(19) United States
(12) Patent Application Publication
(10) Pub. No.: US 2025/0080228 A1
(43) Pub. Date: Mar. 6, 2025

(54) DELAY CONTROL CIRCUIT, OPTICAL TRANSMITTER, AND DELAY CONTROL METHOD

(71) Applicant: Fujitsu Limited, Kawasaki-shi (JP)

(72) Inventors: Yukito TSUNODA, Sagamihara (JP); Yutaro ENOMOTO, Sagamihara (JP)

(73) Assignee: Fujitsu Limited, Kawasaki-shi (JP)

(21) Appl. No.: 18/794,480

(22) Filed: Aug. 5, 2024

(30) Foreign Application Priority Data
Aug. 29, 2023 (JP) 2023-138621

(51) Int. Cl. H04B 10/50; G02B 6/293; G02F 1/21; G02F 1/225

(52) U.S. Cl. CPC H04B 10/50577; G02B 6/29355; G02F 1/212; G02F 1/225

(57) ABSTRACT

A delay control circuit includes a delay circuit configured to delay, by a predetermined delay, a signal input to a plurality of electrode segments provided in series along one or both of two waveguides of a Mach-Zehnder interferometer of an optical modulator, a monitor configured to monitor a power of a baud rate frequency component including a frequency having a value that is equal to a baud rate or an integer multiple of the baud rate, or a power of a beat frequency component of the baud rate frequency component, from output light of the optical modulator, and a control circuit configured to control a delay amount of the delay circuit so as to maximize a monitored power of the baud rate frequency component or the beat frequency component.

### CROSS-REFERENCE TO RELATED APPLICATIONS

This application is based upon and claims the benefit of priority of the prior Japanese Patent Application No. 2023-138621, filed on Aug. 29, 2023, the entire contents of which are incorporated herein by reference.

### FIELD

The embodiments discussed herein are related to delay control circuits, optical transmitters, and delay control methods.

### BACKGROUND

A configuration has been proposed in which a signal electrode is segmented into a plurality of electrode segments along one or both of two waveguides forming a Mach-Zehnder interferometer (MZI) of an optical modulator, and each electrode segment is independently driven for each bit of a symbol. Such a configuration may be referred to as an “optical digital-to-analog converter (DAC)”, because a digital signal representing a value of each bit is input to a corresponding electrode segment of the MZI, and an analog signal is generated in an optical domain. A configuration has been proposed to adjust a timing of an electrical signal supplied to each electrode segment of an optical DAC modulator, as proposed in Japanese Laid-Open Patent Publication No. 2022-24347, for example.

In the optical DAC modulator, the signal input timing among the electrode segments is adjusted at the time of factory shipment or at the time of set-up at a set-up site. Generally, a test signal is input to the electrode segment to be adjusted, and a delay amount of each bit is adjusted manually while observing an eye pattern. During operation of the optical DAC modulator, there is no means for monitoring a timing error among the signals input to the electrode segments. When the signal input timing is out of sync among the electrode segments due to a temperature change or the like in a usage environment or operating environment, the signal waveform deteriorates.

### SUMMARY

Accordingly, it is an object in one aspect of the embodiments to provide a delay control technique for reducing a timing error among different data signals input to a plurality of electrode segments provided in an optical modulator during operation.

According to one aspect of the embodiments, a delay control circuit includes a delay circuit configured to delay, by a predetermined delay, a signal input to a plurality of electrode segments provided in series along one or both of two waveguides of a Mach-Zehnder interferometer of an optical modulator; a monitor configured to monitor a power of a baud rate frequency component including a frequency having a value that is equal to a baud rate or an integer multiple of the baud rate, or a power of a beat frequency component of the baud rate frequency component, from output light of the optical modulator; and a control circuit configured to control a delay amount of the delay circuit so as to maximize a monitored power of the baud rate frequency component or the beat frequency component.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram of an optical transmitter including a delay control circuit according to a first embodiment;

FIG. 2 is a diagram illustrating a baud rate frequency component included in an output of a photodetector;

FIG. 3 is a diagram illustrating a data signal input to an electrode segment of an IQ modulator and a monitor output of the photodetector;

FIG. 4 is a constellation diagram on a complex plane;

FIG. 5A, FIG. 5B, and FIG. 5C are diagrams illustrating data signals input to two electrode segments of an I-phase MZI and an I-phase monitor output;

FIG. 6 is a diagram illustrating a significance of monitoring a frequency component having the same value as a baud rate;

FIG. 7A is a diagram illustrating monitor outputs when there is no signal input timing error between the electrode segments;

FIG. 7B is a diagram illustrating the monitor outputs when there is a signal input timing error between the electrode segments;

FIG. 8 is a diagram illustrating a frequency component extracted by a baud rate frequency filter;

FIG. 9 is a diagram illustrating a relationship of a timing difference between the electrode segments and an intensity of the baud rate frequency component;

FIG. 10 is a flow chart of a delay control method;

FIG. 11A and FIG. 11B are diagrams illustrating effects of the delay control according to the first embodiment;

FIG. 12 is a diagram illustrating a monitoring principle of a second embodiment;

FIG. 13 is a schematic diagram of the optical transmitter including the delay control circuit according to the second embodiment;

FIG. 14 is a diagram illustrating the monitoring principle of a third embodiment;

FIG. 15 is a schematic diagram of the optical transmitter including the delay control circuit according to the third embodiment;

FIG. 16 is a diagram illustrating a power monitor component of the third embodiment;

FIG. 17 is a diagram illustrating a relationship of the timing difference between the electrode segments and an intensity of a beat frequency component;

FIG. 18 is a schematic diagram of the optical transmitter including the delay control circuit according to a fourth embodiment; and

FIG. 19 is a diagram illustrating a relationship of the timing difference between the electrode segments and the intensity of the baud rate frequency component.

### DESCRIPTION OF EMBODIMENTS

Preferred embodiments of the present disclosure will be described with reference to the accompanying drawings.

In the embodiments, during operation of an optical transmitter, input timings of different data signals, that is, different signal bits, that are input to a plurality of electrode segments of an optical modulator are adjusted. In order to perform this adjustment, a frequency component having the same value as a baud rate or a beat frequency of this frequency component is monitored, and a delay amount of each data signal is controlled so as to maximize a monitored power. For example, when the baud rate, that is, a modulation rate is 64 Gbaud, a frequency of 64 GHz or a beat frequency thereof in an optical output of the optical modulator is monitored, and the input timings of the data signals are adjusted based on a monitored result.

Hereinafter, specific configurations and methods of the delay control according to the embodiments will be described with reference to the drawings. The following embodiments are examples for embodying the technical concept of the present disclosure, and the present disclosure is not limited to the described embodiments. a size, a positional relationship, or the like of constituent elements illustrated in the drawings may be exaggerated to facilitate understanding of the present disclosure. The same constituent elements or functions are designated by the same reference numerals or names, and a redundant description thereof may be omitted.

### First Embodiment

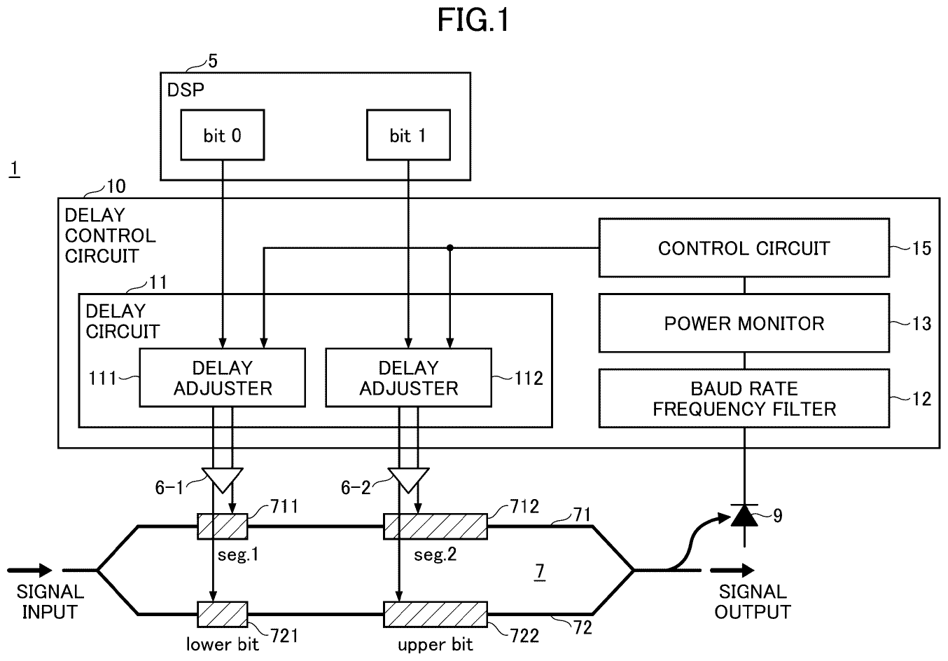

FIG. 1 is a schematic diagram of an optical transmitter 1 including a delay control circuit 10 according to a first embodiment. The optical transmitter 1 includes a digital signal processor (DSP) 5, an optical modulator 7, a delay control circuit 10 configured to control delay amounts of data signals input to the optical modulator 7, and a photodetector 9 configured to detect a portion of output light of the optical modulator 7. Digital drivers 6-1 and 6-2 are arranged between the delay control circuit 10 and the optical modulator 7, and output digital drive signals for driving the optical modulator 7 based on data signals that are delay-adjusted by the delay control circuit 10. The DSP 5, the delay control circuit 10, and the digital drivers 6-1 and 6-2 are included in an electronic circuit. On the other hand, the optical modulator 7 formed of an optical waveguide, and the photodetector 9 configured to detect the portion of the output light of the optical modulator 7 are included in an optical circuit. The photodetector 9 includes a photodiode (PD) and a transimpedance amplifier (TIA), for example, and outputs a voltage signal.

The optical modulator 7 is an MZI type modulator formed by two optical waveguides 71 and 72. At least one of the optical waveguides 71 and 72 is provided with electrode segments according to signals output from the DSP 5. In the example illustrated in FIG. 1, the DSP 5 outputs bit 0 and a bit 1 of a signal. The bit 0 represents a lower bit (or lower-order bit), and the bit 1 represents a higher bit (or higher-order bit). These signal bits are delay-adjusted by the delay control circuit 10, and input to the two electrode segments provided in the optical modulator 7, respectively.

The optical waveguide 71 of the optical modulator 7 is provided with electrode segments 711 and 712, and the optical waveguide 72 of the optical modulator 7 is provided with electrode segments 721 and 722. The electrode segments 711 and 712 and the electrode segments 721 and 722 function as phase shifters configured to shift phases of lights passing through the optical waveguides 71 and 72, by varying refractive indices of the optical waveguides 71 and 72 according to the input signal bits. A length of the electrode segments 712 and 722 (indicated as “seg.2” in FIG. 1) is set to two times a length of the electrode segments 711 and 721 (indicated as “seg.1” in FIG. 1). Thus, a phase shift amount in the electrode segment seg.2 is two times the phase shift amount in the electrode segment seg.1.

The electrode segments 711 and 721 are subjected to a push-pull drive by being supplied with a positive phase signal and a negative phase signal generated by the digital driver 6-1, respectively. The electrode segments 712 and 722 are subjected to a push-pull drive by being supplied with a positive phase signal and a negative phase signal generated by the digital driver 6-2, respectively. When the push-pull drive is not used, the electrode segments seg.1 and seg.2 may be provided in only one of the optical waveguides 71 and 72.

The configuration illustrated in FIG. 1 employs an “optical DAC” in which an electrical digital signal is input to each of the electrode segments seg.1 and seg.2 of the optical modulator 7, and an optical analog signal is generated by the optical modulator 7. However, the “optical DAC” is merely one of application example of the delay control according to the embodiment, and the delay control technique of the present disclosure is also applicable to an optical transmitter employing a system other than the optical DAC.

The delay amounts of the bit 0 and the bit 1 of the signal are controlled, so that the bit 0 is input to the electrode segment seg.1 at a timing when the light incident to the optical modulator 7 passes through the electrode segment seg.1, and the bit 1 is input to the electrode segment seg.2 at a timing when the light incident to the optical modulator 7 passes through the electrode segment seg.2. The adjustment of the signal input timing is performed by the delay control circuit 10, by monitoring a portion of the output light of the optical modulator 7 by the photodetector 9, and using the monitored result in the delay control circuit 10.

The delay control circuit 10 includes a delay circuit 11, a baud rate frequency filter 12, a power monitor 13, and a control circuit 15. The delay circuit 11 includes delay adjusters 111 and 112 configured to individually adjust the delay amount of the signal bits output from the DSP 5. The baud rate frequency filter 12 extracts a frequency having the same value as a baud rate or a frequency that is an integer multiple thereof (these frequency components are also referred to as “baud rate frequency components”) from an output of the photodetector 9. The power monitor 13 monitors a power of an electrical signal having the baud rate frequency. The control circuit 15 controls the delay amounts of the delay adjusters 111 and 112 so that the power of the baud rate frequency component monitored by the power monitor 13 becomes a maximum.

As will be described later, the power of the baud rate frequency component is correlated to an error amount of the input timing of the data signals supplied to the electrode segments seg.1 and seg.2 of the optical modulator 7. Accordingly, the input timing among the different data can be optimized, by monitoring the baud rate frequency component from the output light of the optical modulator 7 during operation, and adjusting the delay amount so that the power of the baud rate frequency component becomes a maximum.

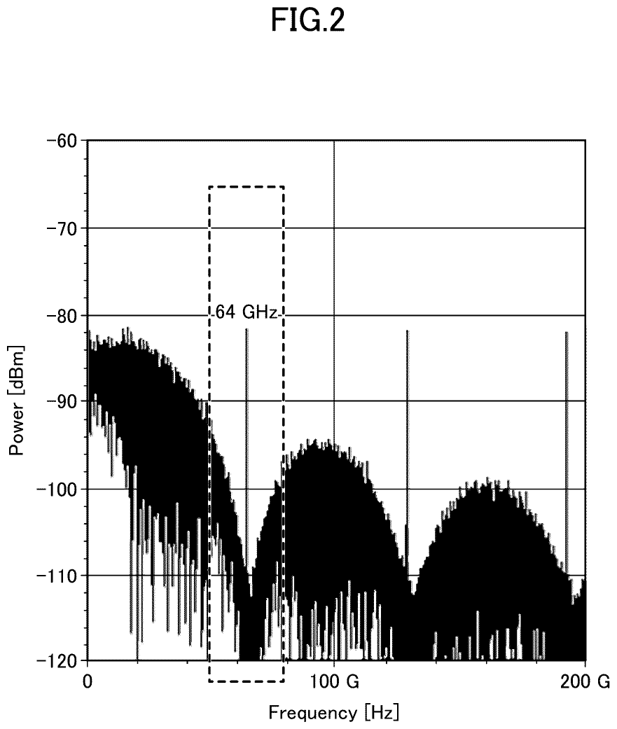

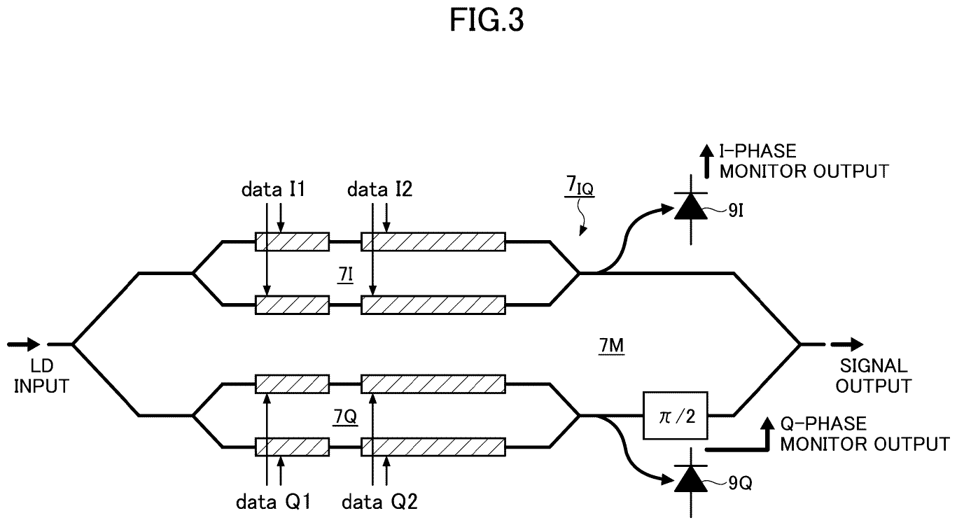

FIG. 2 is a diagram illustrating the baud rate frequency component included in the output of the photodetector 9. A power spectrum of the electrical signal output from the photodetector 9 diminishes at a constant frequency interval, that is, at a constant period. A sharp peak appears at or near the frequency at which the light is quenched. A peak of the power spectrum that appears next to the quench is a harmonic component. For example, when the baud rate is 64 Gbaud, the peak appears at a position of 64 GHz in the power spectrum, and peaks appear at positions of 128 GHz and 192 GHz at an interval of 64 GHz. The peak appearing for every 64 GHz corresponds to a period of switching between the bits when the light that is phase-modulated by the optical modulator 7 is detected as electric power by the photodetector 9, as will be described later in more detail with reference to FIG. 3 through FIG. 6.

FIG. 3 illustrates data signals input to electrode segments of an IQ modulator 7_{IQ} and the monitor output of the photodetector. The IQ modulator 7_{IQ} is a nested optical modulator in which an I-phase MZ modulator 7I and a Q-phase MZ modulator 7Q are connected in parallel to form a parent MZ modulator 7M. A portion of light output from the I-phase MZ modulator 7I is branched and input to a photodetector 9I as monitored light. A detection result of the monitored light by the photodetector 9I is input to an I-phase delay control circuit 10 (refer to FIG. 1) as I-phase monitor output, and used for an I-phase delay control. A portion of light output from the Q-phase MZ modulator 7Q is branched and input to a photodetector 9Q as monitored light. A detection result of the monitored light by the photodetector 9Q is input to a Q-phase delay control circuit 10 (refer to FIG. 1) as Q-phase monitor output, and used for a Q-phase delay control.

Electric fields having two kinds of intensities are applied to the I-phase MZ modulator 7I and the Q-phase MZ modulator 7Q, respectively, and four kinds of signals (two intensities×two phases) having two phases (0 radian and π radians) are generated. The light passing through the I-phase MZ modulator 7I and the light passing through the Q-phase MZ modulator 7Q are combined with a phase difference of 90° (π/2), and a quadrature amplitude modulation (QAM) optical signal is output from the IQ modulator 7_{IQ}.

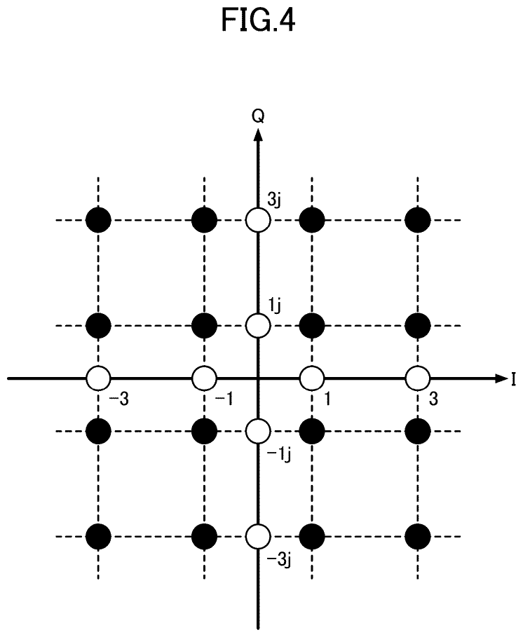

FIG. 4 is a constellation diagram on a complex plane. The signals of 2 intensities×2 phases generated by the I-phase MZ modulator 7I can be expressed as 3π/16, π/16, −π/16, and −3π/16 on an I-axis, for example. In FIG. 4, “π/16” is omitted, and values representing states of the signals are simply indicated as 3, 1, −1, and −3. The signals of 2 intensities×2 phases generated by the Q-phase MZ modulator 7Q and given the phase difference of π/2 are expressed as 3j, 1j, −1j, and −3j on a Q-axis. Sixteen signal points are specified on the complex plane, from combinations of four kinds of signals of the I-phase and four kinds of signals of the Q-phase.

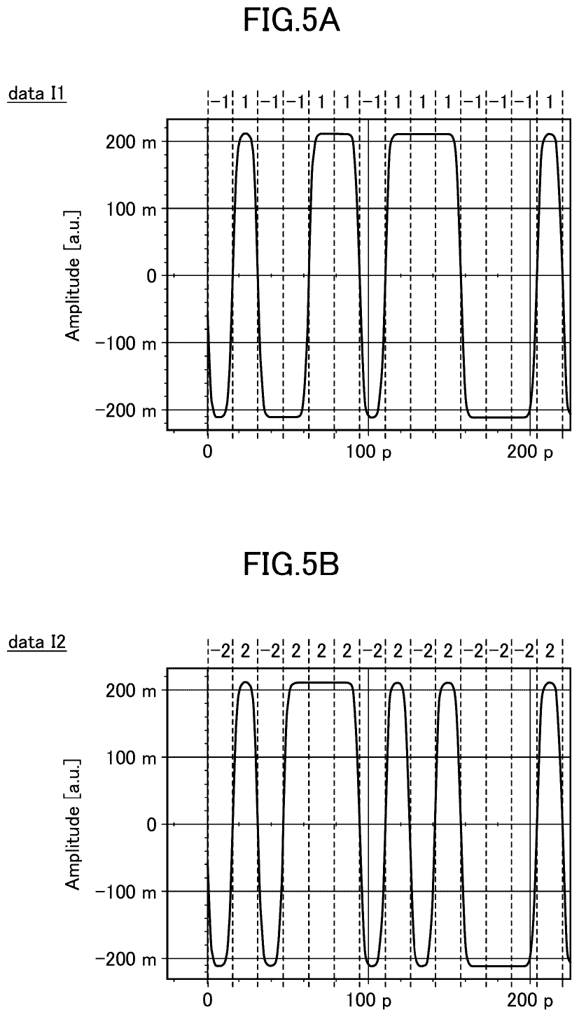

FIG. 5A, FIG. 5B, and FIG. 5C illustrate two data signals input to two electrode segments of the I-phase MZ modulator 7I and an I-phase monitor output. FIG. 5A illustrates a signal waveform of data I1 input to the electrode segment (seg.1) for the lower bit, FIG. 5B illustrates a signal waveform of data I2 input to the electrode segment (seg.2) for the upper bit, and FIG. 5C illustrates an output waveform of the I-phase photodetector 9I. The data I1 is an NRZ signal, and an intensity thereof is represented by “1” and “−1”, for example. The data 12 is an NRZ signal, and an intensity thereof is represented by “2” and “−2”, for example.

An amplitude of the modulated light output from the I-phase MZ modulator 7I takes one of values 3, 1, −1, and 1 depending on a combination of the data I1 and the data I2. However, as illustrated in FIG. 5C, the photodetector 9I detects a “power” (a square of the amplitude) of the modulated light, and thus, the photodetector 9I detects the modulated light as having the same power when the amplitude of the modulated light is −3 and when the amplitude of the modulated light is 3.

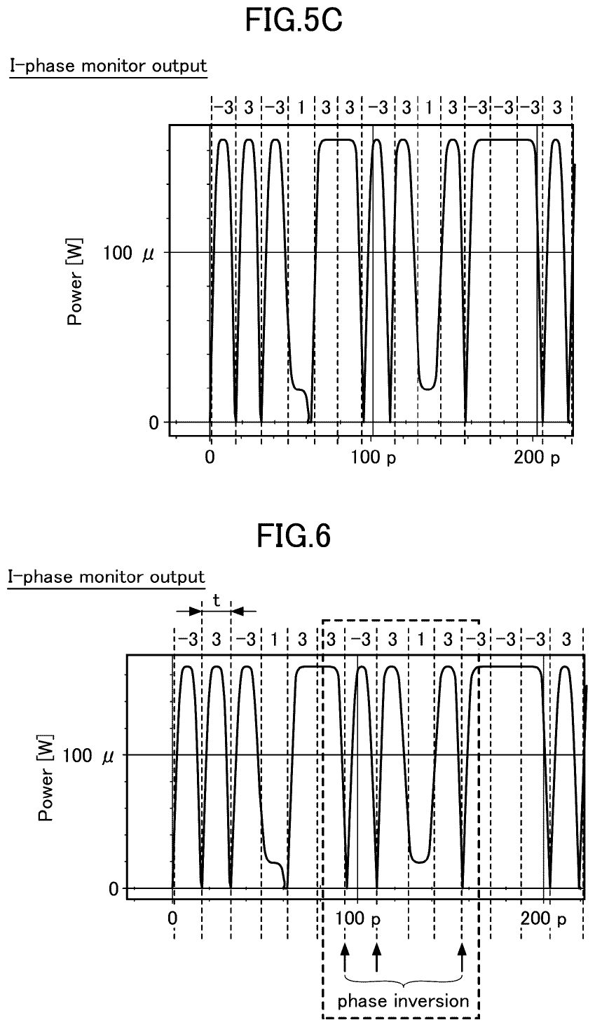

FIG. 6 is a diagram illustrating a significance of monitoring the baud rate frequency component having the same value as the baud rate. In a case where the optical signal output from the MZ modulator 7I is monitored by the photodetector 9I including the photodiode (PD), the optical power is detected, and phase information of the optical signal is lost. Due to the 2-bit data input, the modulated light of the I-phase takes four values of 3, 1, −1, and −3, and the monitored result in the photodetector 9I assumes a binary value of “1” or “3”. Focusing on the relationship between “−3” and “3”, when the same modulation value such as “3” or “−3”, for example, continues, the monitor power does not return to zero and a peak level is maintained. On the other hand, when the modulated light makes a transition between “−3” and “3”, the signal of “−3” is inverted into “3” when detecting the optical power, but the actual modulated light passes through “0”. For this reason, in a region of interest surrounded by a bold broken line in FIG. 6, when the signal value makes a transition from “−3” to “3” or from “3” to “−3”, a dip in which the monitor power becomes zero occurs between the peaks. An interval (or a pulse width) t of the dip represents a period of the pulse that varies in an order of “zero power→peak→zero power” within one bit, and corresponds to a modulation rate. For example, in a case where a transmission rate of 128 bps is to be achieved by 2 bits, the modulation rate is 64 Gbaud. The dip interval, that is, the pulse width switched by one bit in one period is 15.625 picoseconds (ps), and a peak occurs at 64 GHz and at frequency positions that are integer multiples of 64 GHz in the frequency domain. The baud rate frequency and the components that are integer multiples thereof are collectively referred to as “baud rate frequency components”.

When the input timing of the data signal supplied to each of the electrode segments is out of sync, the signal inversion, that is, the bit switching state, is changed by the power detection of the photodetector 9, and the intensity of the peak appearing at the baud rate frequency (64 GHz in this example) or at the frequency positions that are integer multiples of the baud rate frequency varies. Accordingly, by observing a power variation of the baud rate frequency component, it is possible to adjust the signal input timings between the electrode segments.

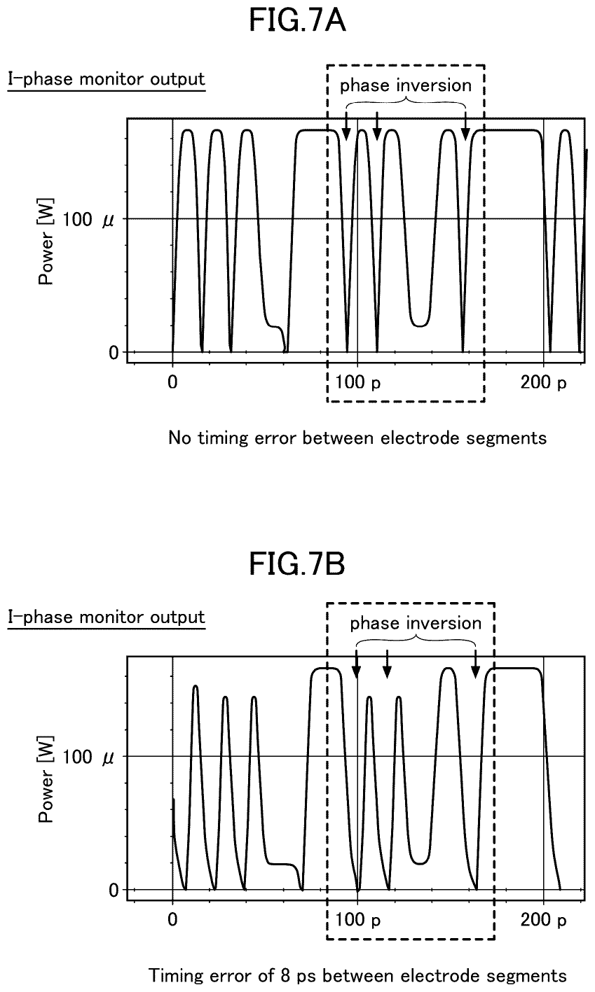

FIG. 7A illustrates the monitor output when there is no (or minimum) signal input timing error between the electrode segments. FIG. 7B illustrates the monitor output when there is a signal input timing error between the electrode segments. As illustrated in FIG. 7A, when there is no or minimum signal input timing error between the electrode segments, a peak of a pulse generated at the same period as the interval of the dip becomes a maximum. In contrast, when the signal input timing to the electrode segment is shifted by 8 picoseconds, the intensity of the pulse that varies in an order “dip→peak→dip” within one bit decreases. As a result, the power of the baud rate frequency component decreases in the power spectrum.

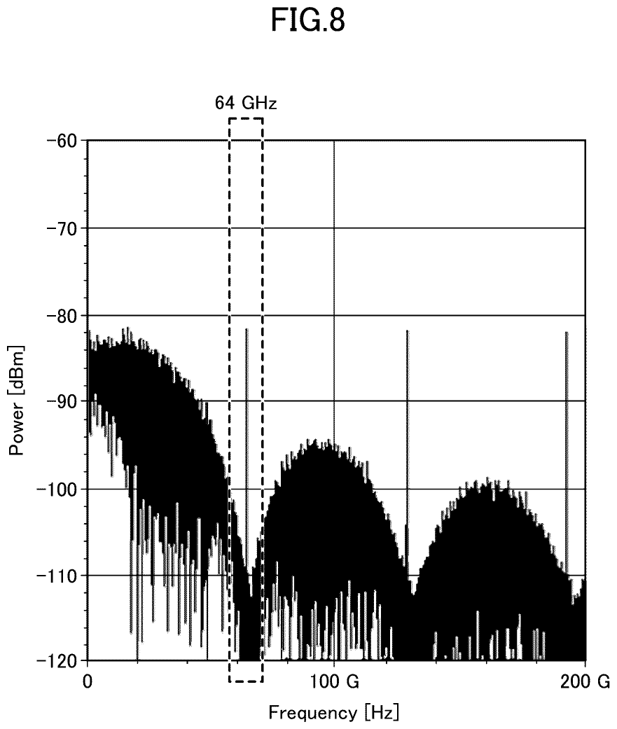

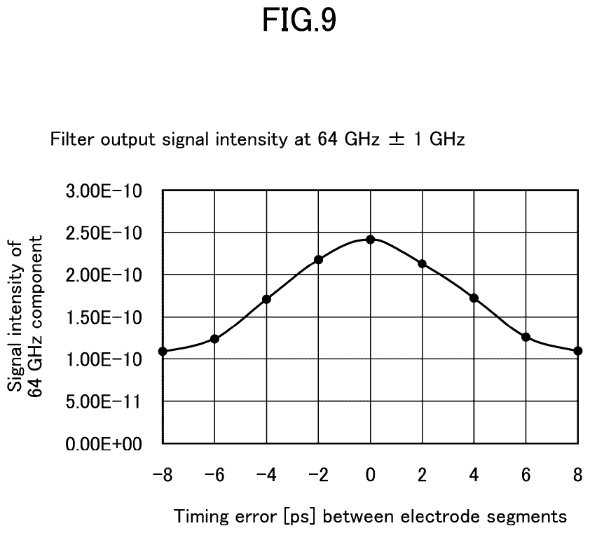

FIG. 8 illustrates the frequency components extracted by the baud rate frequency filter 12. FIG. 9 illustrates a relationship of the timing difference between the electrode segments and the intensity of the baud rate frequency component. As described above, the monitored intensity of the baud rate frequency component depends on the timing error of the input signal. In a case where different signal bits are input between the electrode segments as in the case of QAM modulation, the timing error between the electrode segments can be detected by monitoring the power of the baud rate frequency component, and the delay can be controlled in a direction so as to reduce the timing error.

When the modulation rate is 64 Gbaud, the baud rate frequency filter 12 extracts a frequency component of 64 GHz±1 GHz, for example. The delay control circuit 10 controls the delay amount of each input signal so that the power of the extracted frequency component becomes a maximum. In a case where the timing at which the signal bit 0 is input to the electrode segment seg.1 and the timing at which the signal bit 1 is input to the electrode segment seg.2 are relatively matched, the signal bit 0 is input at a timing when the incident light to the optical modulator 7 passes through the electrode segment seg.1, and the signal bit 1 is input at the timing when the incident light passes through the electrode segment seg.2. In this state, the power of the frequency component of 64 GHz to be monitored becomes a maximum. The intensity of the frequency component of 64 GHz decreases regardless of whether the input timing of one of the signals becomes advanced or delayed with respect to the input timing of the other of the signals. This is because a switching accuracy of “dip→peak→dip” by the signal inversion deteriorates due to the timing error of signal input.

The delay control circuit 10 monitors the power of the baud rate frequency component (64 GHz±1 GHz in this example) from the electrical output of the photodetector 9, and adjusts the delay amounts of the delay adjusters 111 and 112 of the delay circuit 11 so that the monitor power becomes a maximum.

### (Delay Control Method)

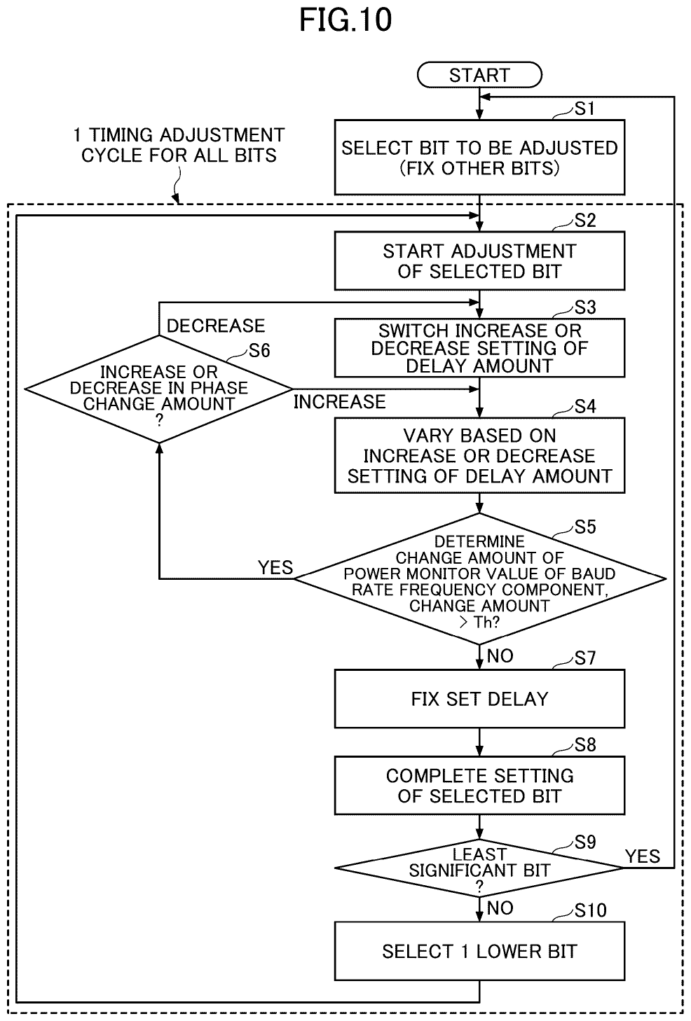

FIG. 10 is a flow chart of a delay control method performed by the delay control circuit 10. First, a bit to be adjusted is selected from among two or more bits input to the optical modulator 7, and the delay amounts of the other bits are fixed (step S1). For example, the selection is made from a most significant bit having a largest contribution to the modulation. The delay adjustment is started with the selected bit (step S2).

The delay amount of the delay adjuster corresponding to the bit to be adjusted is set in an increasing or decreasing direction (step S3), and the delay amount is changed in the set direction with a predetermined step size (step S4). The baud rate frequency component is extracted from the output of the photodetector 9 by the baud rate frequency filter 12, and the power of the extracted baud rate frequency component is monitored by the power monitor 13. The control circuit 15 determines whether or not a change amount of the power monitor value exceeds a threshold value Th (step S5).

In a case where the change amount of the power monitor value is greater than the threshold value Th (YES in step S5), a determination is made to determine whether the direction of the change is increase or decrease (step S6). In a case where the direction of the change is decrease, that is, in a case where the power of the monitored baud rate frequency component is decreasing, the direction of the adjustment is incorrect, and thus, the process returns to step S3 where the direction of the adjustment of the delay amount is switched to the opposite direction. In a case where the direction of the change is increase, the direction of the adjustment is correct, and thus, the process returns to step S4 where the delay amount is changed in the set direction. If the amount of change in the monitored value converges to a value less than or equal to the threshold value Th (NO in step S5), the delay amount is fixed to the delay amount set at that point in time (step S7), and the setting of the delay amount of the current bit is completed (step S8).

Next, a determination is made to determine whether or not the selected bit is the least significant bit (step S9). In a case where the selected bit is not the least significant bit (NO in step S9), one lower bit that is one place lower in order than the selected bit is selected (step S10), and the processes of step S2 and subsequent steps are repeated. On the other hand, in a case where the selected bit is the least significant bit (YES in step S9), the process returns to step S1, and the processes from step S2 to step S10 are repeated during operation. By repeating steps S2 to S10, an adjustment cycle is completed for all of the bits forming the data signal, and this adjustment cycle is repeated during operation by regarding this adjustment cycle as one cycle of the timing adjustment for all of the bits.

The delay control method according to the embodiment does not require stopping the actual operation of the optical transmitter 1 and inputting a test signal when performing an input timing adjustment between different bits. Because the input timing between the different bits can be repeatedly adjusted by utilizing the actual data in a background during operation of the optical transmitter 1, a signal quality of the multilevel optical signal can be maintained even when the environment, such as the temperature or the like, changes.

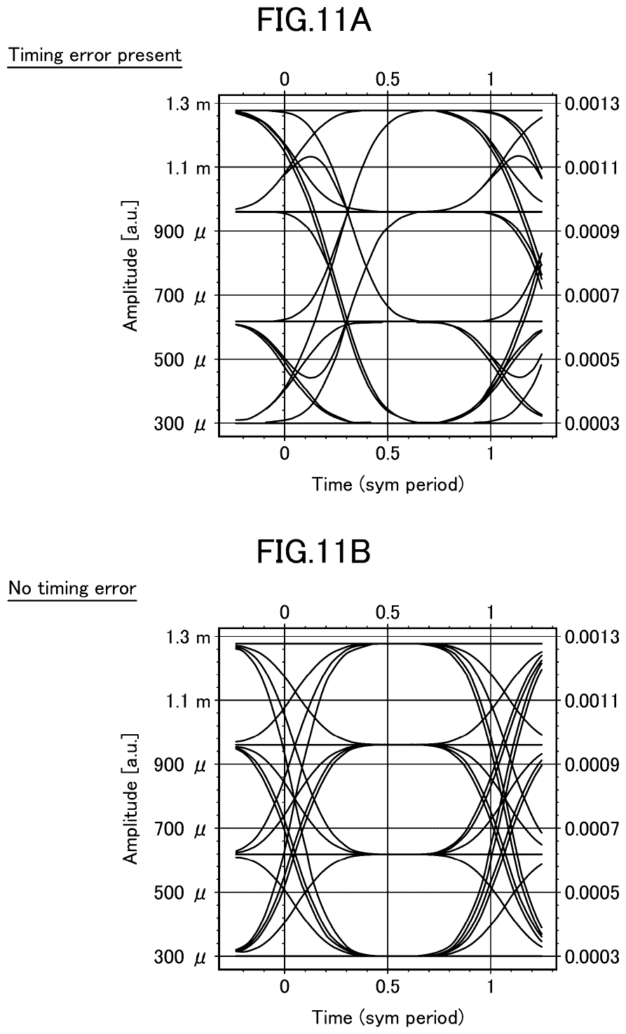

FIG. 11A and FIG. 11B are diagrams illustrating effects of the delay control according to the first embodiment. In FIG. 11A and FIG. 11B, the ordinate indicates the amplitude in arbitrary units (a.u.), and the abscissa indicates the time in symbol period (sym period). FIG. 11A illustrates an eye pattern when there is an input timing error between different bits, that is, between the data signals input to different electrode segments. A 16QAM signal for pulse amplitude modulation 4 (PAM4) transmission illustrated in FIG. 4 is generated using the two bits of bit 0 and bit 1. When there is an input timing error between the bit 0 and the bit 1, a delay occurs in a rise time of the signal, the eye opening changes, and the waveform deteriorates.

By performing the delay control of FIG. 10, a good eye pattern illustrated in FIG. 11B is obtained. By performing the control so that the power of the monitored baud rate frequency component becomes a maximum, the delay amount with respect to each of the signal bit 0 and the signal bit 1 is set correctly, and a substantially uniform eye opening is obtained among the four levels. Even when the delay amount is set correctly at the time of shipment, the timings at which the signal bit 0 and the signal bit 1 are applied may become out of sync with respect to the light passing directly below the electrode segments seg.1 and seg.2 during operation due to an environmental temperature variation or a process variation. Even in such a case, the delay control circuit 10 according to the embodiment repeatedly performs the delay control during operation, and thus, it is possible to maintain a good signal quality regardless of a variation in a manufacturing process or an installation environment.

### Second Embodiment

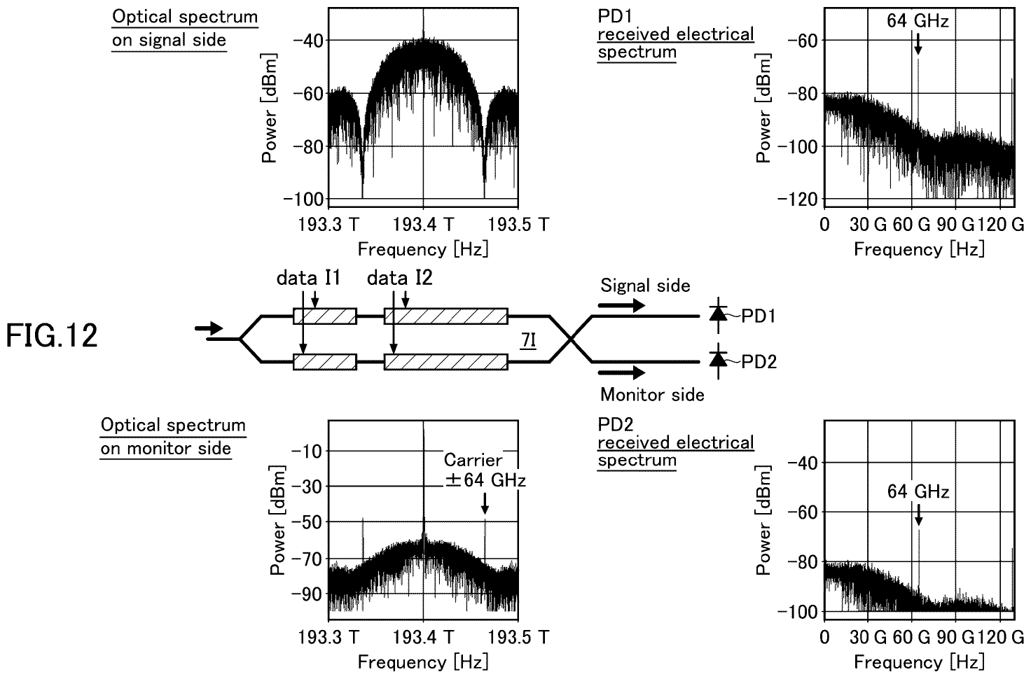

FIG. 12 is a diagram illustrating a monitoring principle of a second embodiment. In the first embodiment, the electrical signal of the baud rate frequency (for example, 64 GHz) is extracted from the output of the photodetector 9 using the baud rate frequency filter 12, and the power of the extracted electrical signal is monitored. In order to monitor the power of a high-speed electrical signal of 64 GHz, a high-speed and high-precision frequency filter is required. In the second embodiment, an optical frequency component corresponding to the baud rate is extracted in an optical spectrum stage. For example, in a case where the baud rate is 64 Gbaud, an optical frequency component that is spaced apart from a center frequency of the carrier wave by 64 GHz in the positive or negative direction, is separated from the output light of the optical modulator. The separated optical frequency component is detected by the photodetector 9, and the power of the baud rate frequency component is monitored from the electrical output of the photodetector 9.

In FIG. 12, two signal bits of data I1 and data I2 are input to two electrode segments provided in each arm of the MZ modulator (for example, the I-phase MZ modulator 7I illustrated in FIG. 3). A symbol rate, that is, the modulation rate, is set to 64 Gbaud. A photodiode PD1 is connected to a signal output side of the MZ modulator 7I, a photodiode PD2 is connected to a monitor side of the MZ modulator 71, and an optical spectrum and an electric spectrum are compared on the signal output side and the monitor side. Although a 64 GHz component appears in the electric spectrum of the optical signal detected in the photodiode PD1, a sharply projecting peak is buried in the optical signal power and is not observed in the spectrum of the optical signal input to the photodiode PD1. On the other hand, in the optical spectrum of the light incident to the monitor side of the photodiode PD2, sharp peaks are observed at positions spaced apart from the center frequency (193.4 THz) of the carrier wave in the positive direction and the negative direction. By extracting the peak in the optical spectrum stage, the power of the 64 GHz component can easily be monitored in the electrical signal.

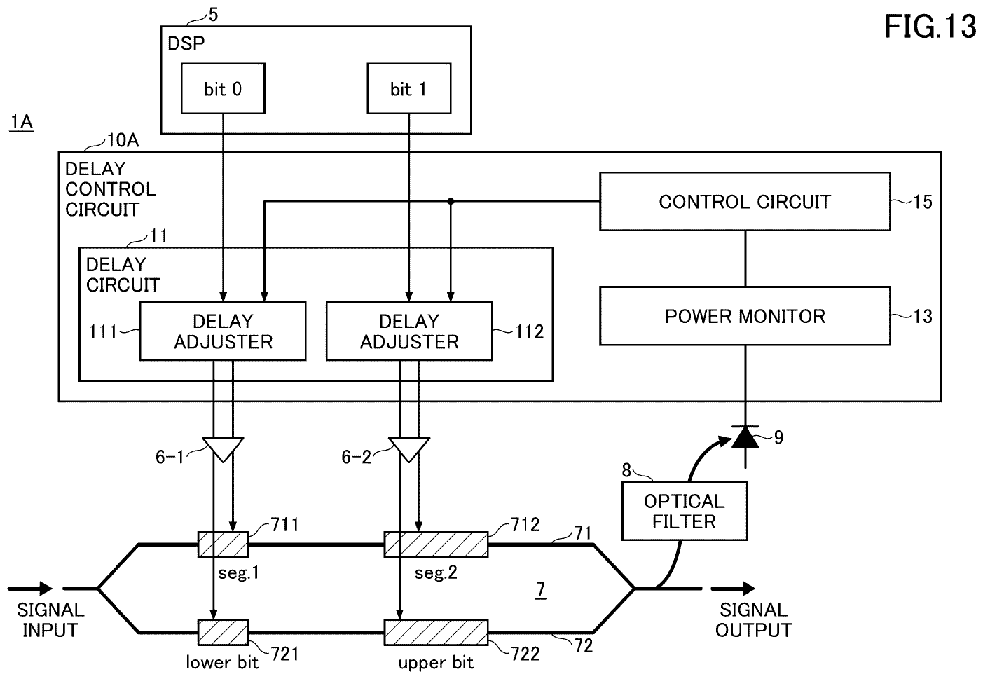

FIG. 13 is a schematic diagram of an optical transmitter 1A including a delay control circuit 10A according to the second embodiment. The optical transmitter 1A includes a DSP 5, the delay control circuit 10A, an optical modulator 7, an optical filter 8 configured to extract a predetermined frequency component from the output light of the optical modulator 7, and a photodetector 9. Digital drivers 6-1 and 6-2 are disposed between the delay control circuit 10A and the optical modulator 7. The optical filter 8 disposed on the output side of the optical modulator 7 may have any configuration as long as the optical filter 8 is able to extract a specific frequency component of the light. For example, an optical filter having asymmetric Mach-Zehnder interferometers (MZIs) formed of silicon photonics waveguides connected in series, or an optical filter having an AMZ triplet of three tree-connected MZIs as a unit structure, can be used for the optical filter 8. In such optical filters, only light having a desired wavelength (that is, a desired frequency) can be transmitted by controlling a difference between effective optical path lengths of the two waveguides of the AMZ.

The spectrum of the output light of the optical filter 8 includes the peaks that appear at positions spaced apart from the center frequency of the carrier wave by the baud rate frequency in both the positive direction and the negative direction. These peak are the optical signal component modulated by the digital signal input to the optical modulator 7. The photodetector 9 detects the light transmitted through the optical filter 8, and outputs an electrical signal. The electrical signal output from the photodetector 9 is input to the delay control circuit 10A, and the power is measured by the power monitor 13. The control circuit 15 controls the delay amounts of the delay adjusters 111 and 112 of the delay circuit 11 so that the power monitored by the power monitor 13 becomes a maximum.

In the configuration of the second embodiment, even when a high-performance electric frequency filter (or high efficiency filter) is not used, the delay amount between different signal bits input to the optical modulator 7 can be optimized, by monitoring the power of the baud rate frequency component from a component transmitted through the optical filter 8.

### Third Embodiment

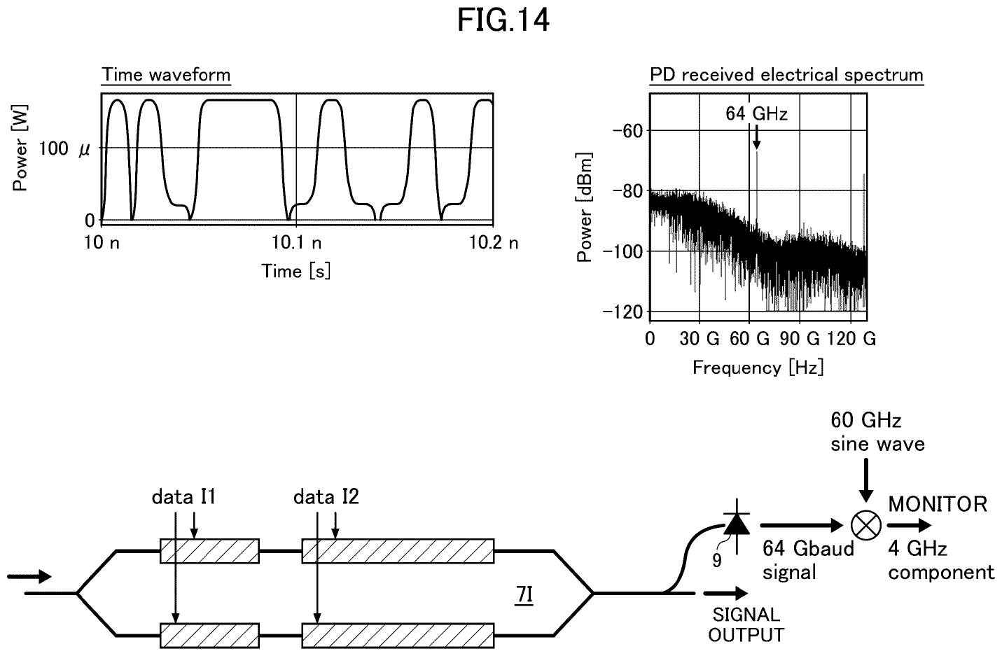

FIG. 14 is a diagram illustrating the monitoring principle of a third embodiment. As described above, because a high-precision frequency filter is required to separate a high-frequency electrical signal, the third embodiment converts the baud rate frequency component into a low-frequency signal in order to monitor the power. As described with reference to FIG. 6, a time waveform of the signal detected by the photodetector 9 has a dip where the power becomes zero, at a position where the data value is inverted. A time interval of the dip, that is, the pulse width, corresponds to a modulation period of one bit in one period. In the case where the modulation rate is 64 Gbaud, the peak occurs at 64 GHz and at frequency positions that are integer multiples of 64 GHz in the electric spectrum output from the photodetector 9 and at positions of integer multiples thereof. With respect to the frequency component of 64 GHz, another signal having a slightly different frequency is caused to interfere, thereby enabling a beat frequency equal to a difference between the two frequencies to be obtained.

For example, the beat frequency of 4 GHz can be obtained by multiplying a sine wave (or sinusoidal wave) of 60 GHz with respect to the peak of 64 GHz. By monitoring the power of the beat frequency, the delay amounts of the data I1 and the data I2 can be controlled correctly.

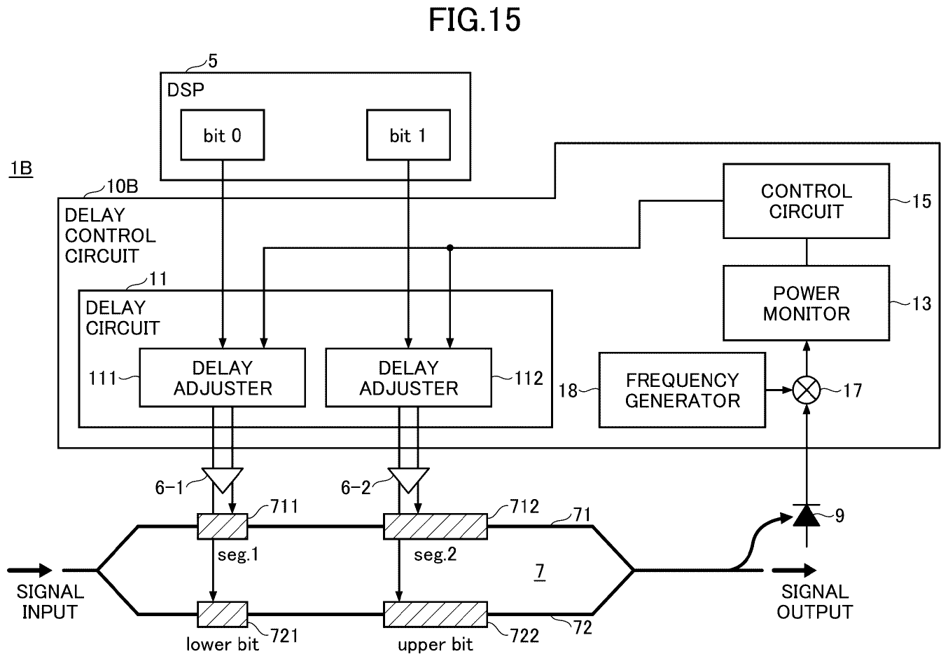

FIG. 15 is a schematic diagram illustrating an optical transmitter 1B including a delay control circuit 10B according to the third embodiment. The optical transmitter 1B includes a DSP 5, the delay control circuit 10B, an optical modulator 7, and a photodetector 9 configured to detect a portion of the output light of the optical modulator 7. Digital drivers 6-1 and 6-2 are disposed between the delay control circuit 10B and the optical modulator 7. The electrical signal output from the photodetector 9 is input to the delay control circuit 10B.

The delay control circuit 10B includes a delay circuit 11, a power monitor 13, a control circuit 15, a multiplier 17, and a frequency generator 18. The frequency generator 18 generates a frequency slightly different from the baud rate frequency. For example, in a case where the baud rate frequency is 64 GHz, the frequency generator 18 generates a frequency of 60 GHz. This frequency of 60 GHz is used as a clock frequency for mixing. The multiplier 17 multiplies the clock signal of having the frequency of 60 GHz to the electrical signal input from the photodetector 9. By this multiplication, the 64 GHz component included in the output of the photodetector, and a beat signal of a difference between the 64 GHz component and the clock frequency are output from the multiplier 17.

The output of the multiplier 17 is supplied to the power monitor 13. The power monitor 13 monitors the power of the beat frequency. A filter may be disposed between the multiplier 17 and the power monitor 13 to extract a frequency component of 4 GHz. Compared to the electrical signal of 64 GHz, the electrical signal of 4 GHz can be separated more easily, and the power monitoring for the delay control is facilitated.

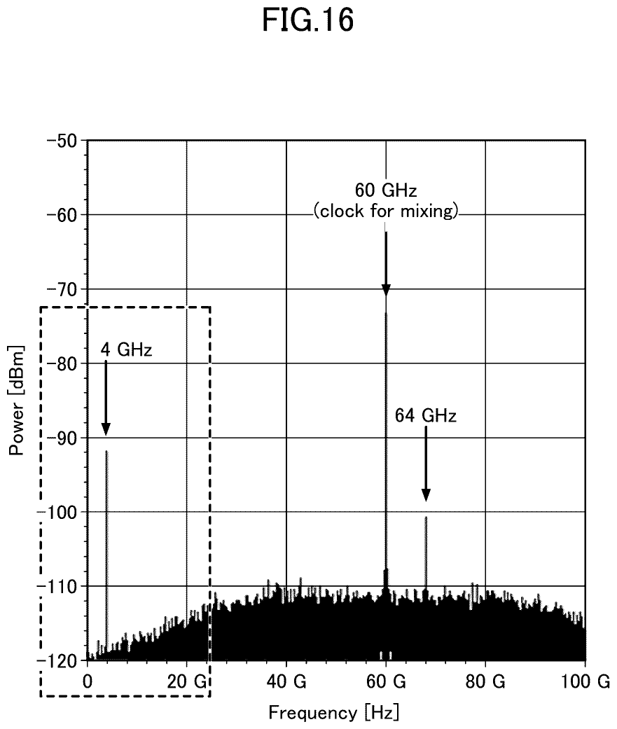

FIG. 16 illustrates a power monitor component of the third embodiment. The spectrum of the electrical signal output from the photodetector 9 includes a peak projecting at the baud rate frequency (64 GHz in this example). By multiplying the clock frequency of 60 GHz with respect to this electrical signal, a sharp peak appears at a difference frequency of 4 GHz. The low beat frequency can be separated more easily compared to the baud rate frequency of 64 GHz, and the power monitoring is facilitated.

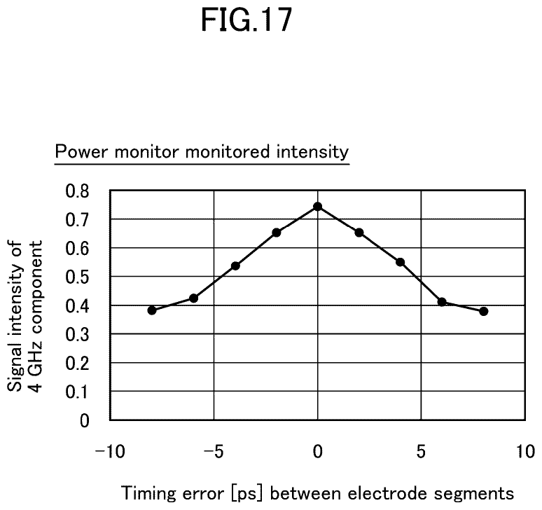

FIG. 17 illustrates a relationship of the timing difference between the electrode segments and an intensity of the beat frequency component. In a case where the input timing of the data I2 to the electrode segment seg.2 is used as a reference timing, the timing difference between the electrode segments seg.1 and seg.2 is 0 ps when the input timing of the data I1 to the electrode segment seg.1 matches the reference timing. In this state, the power monitor intensity of the 4 GHz component becomes a maximum. The power monitor intensity of the 4 GHz component decreases as the timing difference between the electrode segments becomes larger, that is, regardless of whether the timing at which the data I1 acts on the light passing through the electrode segment seg.1 becomes advanced or delayed with respect to the timing at which the data 12 is input to the electrode segment seg.2.

The control circuit 15 controls the delay amounts of the delay adjusters 111 and 112 of the delay circuit 11, so that the power of the monitored beat frequency becomes a maximum. The configuration of the third embodiment enables the power of the baud rate frequency component to be easily monitored, by extracting the beat frequency component.

### Fourth Embodiment

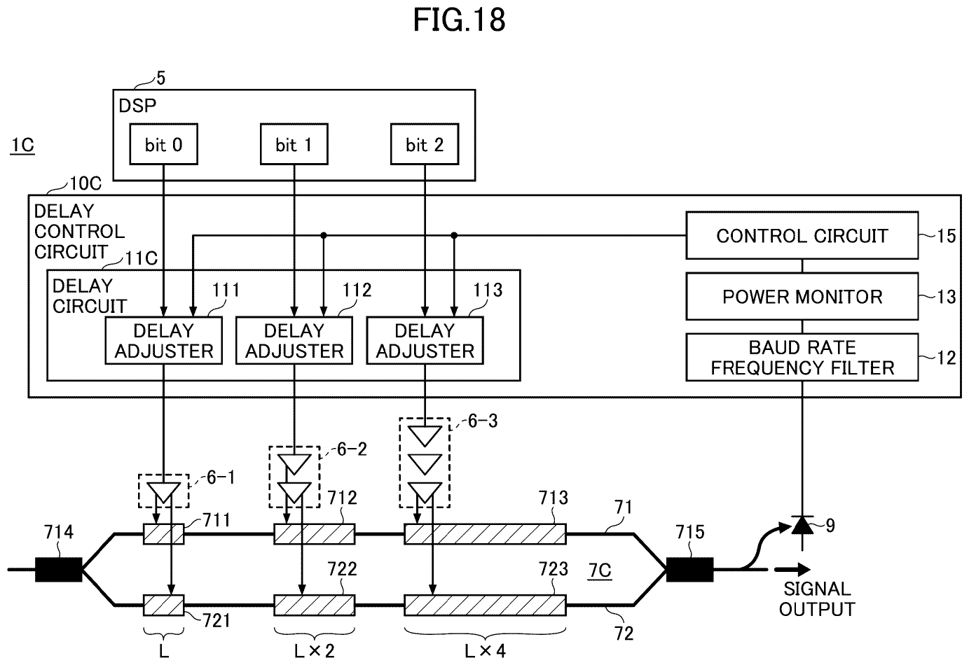

FIG. 18 is a schematic diagram of an optical transmitter 1C including a delay control circuit 10C according to a fourth embodiment. The number of bits input to the optical modulator is not limited to two bits, and a signal of three or more bits may be input to the optical modulator. In the fourth embodiment, the input timing among the data signals input to three electrode segments is adjusted.

The optical transmitter 1C includes a DSP 5, an optical modulator 7C, the delay control circuit 10C configured to control delay amounts of data signals input to the optical modulator 7C, and a photodetector 9 that detects a portion of light output from the optical modulator 7C. Digital drivers 6-1, 6-2, and 6-3 are disposed between the delay control circuit 10C and the optical modulator 7C, and drive the optical modulator 7C based on the data signals that are delay-adjusted by the delay control circuit 10C.

The optical modulator 7C is an MZ modulator formed by two optical waveguides 71 and 72 are connected between couplers 714 and 715. The optical waveguide 71 is provided with electrode segments 711, 712, and 713 which receive a bit 0, a bit 1, and a bit 2 of the signal output from the DSP 5, respectively. The optical waveguide 72 is provided with electrode segments 721, 722, and 723 which receive the bit 0, the bit 1, and the bit 2 of the signal output from the DSP 5. In this example, the electrode segments corresponding to the signal bits are provided in both of the two optical waveguides 71 and 72 and are subjected to the push-pull drive, but the electrode segments may be provided in only one of the optical waveguides 71 and 72.

When a length of the electrode segments 711 and 721 which receive the bit 0 of the signal is denoted by L, a length of the electrode segments 712 and 722 which receive the bit 1 of the signal is set to 2L, and a length of the electrode segments 713 and 723 which receive the bit 2 of the signal is set to 4L. A phase shift amount in the electrode segments 712 and 722 is two times a phase shift amount in the electrode segments 711 and 721, and a phase shift amount in the electrode segments 713 and 723 is four times the phase shift amount in the electrode segments 711 and 721.

The delay amount of the bit 0 of the signal is controlled so that the bit 0 of the signal is input to the electrode segments 711 and 721 at a timing when the light incident to the optical modulator 7C passes through the electrode segments 711 and 721. The delay amount of the bit 1 of the signal is controlled so that the bit 1 of the signal is input to the electrode segments 712 and 722 at a timing when the light passes through the electrode segments 712 and 722. The delay amount of the bit 2 of the signal is controlled so that the bit 2 of the signal is input to the electrode segments 713 and 723 at a timing when the light passes through the electrode segments 713 and 723. Such timing adjustments of the input signal bits is performed by the delay control circuit 10C, based on the detection result of the photodetector 9 that detects a portion of the light output from the optical modulator 7C.

The delay control circuit 10C includes a delay circuit 11C, a baud rate frequency filter 12, a power monitor 13, and a control circuit 15. The delay circuit 11C includes delay adjusters 111, 112, and 113 configured to individually adjust the delay amount of the signal bits output from the DSP 5. The baud rate frequency filter 12 extracts a baud rate frequency component, which is a frequency having the same value as the baud rate, from the output of the photodetector 9. The power monitor 13 monitors the power of the baud rate frequency component. The control circuit 15 controls the delay amounts of the delay adjusters 111, 112, and 113, so that the power of the baud rate frequency component monitored by the power monitor 13 becomes a maximum.

The delay control circuit 10C performs a delay control similar to that of the delay control circuit 10 according to the first embodiment, except that the delay control circuit 10C controls the delay amount of three bits. The baud rate is set to 64 Gbaud, similar to the first embodiment. Because a 3-bit signal is used in this example, the transmission rate is 192 Gbps. The 64 GHz component included in the power spectrum of the output of the photodetector 9 is monitored, and the delay amount of the bit 0, the bit 1, and the bit 2 is adjusted so that the power of the output of the photodetector 9 becomes a maximum. As described above with reference to FIG. 10, because the effects of the bit 2 having the largest modulation amount are dominant, it is preferable to adjust the timing in an order starting from the delay amount of the bit 2.

The configuration of the delay control circuit 10A according to the second embodiment or the delay control circuit 10B according to the third embodiment may be used in the case where the 3-bit signal is input. In the case where the delay control circuit 10A according to the second embodiment is used, the optical filter 8 is disposed between the coupler 715 and the photodetector 9, and the baud rate frequency component is extracted from the optical spectrum. In the case where the delay control circuit 10B according to the third embodiment is used, the electrical output of the photodetector 9 is multiplied by the clock frequency for mixing, and the power of the beat frequency component is monitored. In either case, a good signal waveform can be maintained during operation, by controlling the delay amount so that the monitored power becomes a maximum.

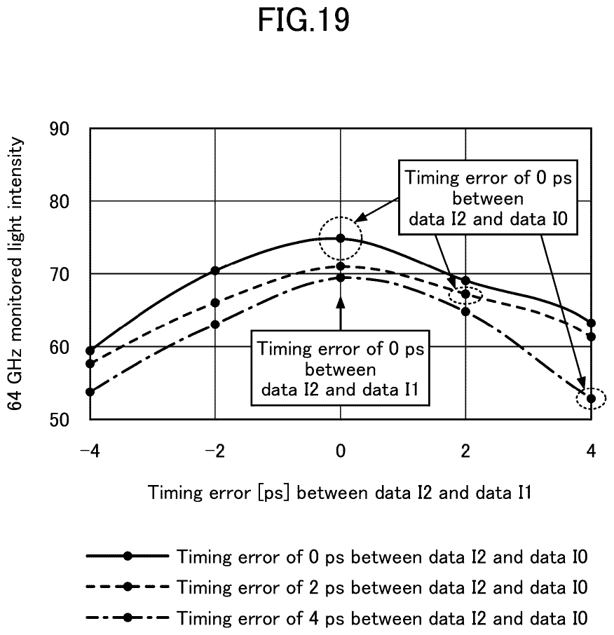

FIG. 19 illustrates a relationship of the timing difference between the electrode segments and the intensity of the monitor light in the fourth embodiment. The most significant bit 2 is represented by data I2, the least significant bit 0 is represented by data I0, and an intermediate bit 1 is represented by data I1. In FIG. 19, the abscissa represents the timing difference between the data I2 and the data I1 of the upper two bits. The ordinate represents the monitored light intensity at the baud rate frequency.

In FIG. 19, a solid line of the graph indicates a timing difference dependency of the monitored light intensity when the timing difference between the bit 2 and the bit 0, that is, between the data I2 and the data I0, is 0 ps. A broken line of the graph indicates the timing difference dependency of the monitored light intensity when the timing difference between the data I2 and the data I0 is 2 ps. A one-dot chain line of the graph indicates the timing difference dependency of the monitored light intensity when the timing difference between the data I2 and the data I0 is 4 ps.

First, the delay amount is relatively controlled so that the timing difference between the data I2 and the data I1 approaches zero. Next, the delay amount is controlled so that the timing difference between the data I2 and the data I0 approaches zero in a state where the timing difference between the data I2 and the data I1 is adjusted to 0 ps or near 0 ps.

For example, when the timing difference between the data I2 and the data I1 of the two higher bits is 4 ps and the timing difference between the data I2 and the data I0 is 4 ps, it appears as if the timings of the three bits match. However, when attention is drawn to the input timing between the data I2 and the data I1, the power of the monitored 64 GHz component is low. By changing the delay amount of the data I2, the power of the 64 GHz monitor light can be made to approach the maximum. In a state where the timing of the data I2 and the timing of the data I1 are matched, the delay adjustment is performed between the data I2 and the data I0 so that the power of the 64 GHz monitor light becomes the maximum. Thus, the signal input timings are matched among the three bits.

Although the delay control focusing on the baud rate frequency is described above based on specific configuration examples, the present disclosure is not limited to the configurations described above. The baud rate is not limited to 64 Gbaud. In the case where the baud rate is 32 Gbaud, the power of a 32 GHz component is monitored, and in the case where the baud rate is 128 Gbaud, the power of a 128 GHz component is monitored. When the baud rate is high, the configurations of the second embodiment and the third embodiment are more advantageous. In the embodiments, the input signal having two or more bits is used, but the present invention is not limited to the application to such an input signal, and can be applied to a binary phase modulation of one bit. In this case, the signal electrode may be segmented into a plurality of electrode segments, and the same signal sequence may be applied to the electrode segments. By segmenting the signal electrode into short electrode segments, a driving power of the optical modulator can be reduced, and a power consumption of the optical transmitter can be reduced. By repeatedly controlling the delay amount of the signal of the same bit applied to each electrode segment during operation, a good signal waveform can be maintained regardless the environmental temperature variation or the process variation.

The method according to the embodiment is a method of monitoring the switching of bits from “−3” to “3”, from “−1” to “1”, or the like, and as illustrated in FIG. 2, instead of the baud rate frequency having the same value as the baud rate, the power of an integer multiple of the baud rate frequency may be monitored. This is because the power of the integer multiple of the baud rate frequency also has a dependency on the timing error between the bits. In this case, the configurations of the second embodiment and the third embodiment are advantageous because the power can be monitored without using a high-precision frequency filter.

According to the present disclosure, it is possible to provide a delay control technique for reducing a timing error among different data signals input to a plurality of electrode segments provided in an optical modulator during operation.

Although the embodiments are numbered with, for example, “first,” “second,” “third,” or “fourth,” the ordinal numbers do not imply priorities of the embodiments. Many other variations and modifications will be apparent to those skilled in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A delay control circuit comprising:
a delay circuit configured to delay, by a predetermined delay, a signal input to a plurality of electrode segments provided in series along one or both of two waveguides of a Mach-Zehnder interferometer of an optical modulator;
a power monitor configured to monitor a power of a baud rate frequency component including a frequency having a value that is equal to a baud rate or an integer multiple of the baud rate, or a power of a beat frequency component of the baud rate frequency component, from output light of the optical modulator; and
a control circuit configured to control a delay amount of the delay circuit so as to maximize a monitored power of the baud rate frequency component or the beat frequency component.

2. The delay control circuit as claimed in claim 1, further comprising:
a baud rate frequency filter configured to extract the baud rate frequency component from an electrical output of a photodetector that detects a portion of the output light of the optical modulator,
wherein the power monitor monitors a power of the baud rate frequency component passed through the baud rate frequency filter.

3. The delay control circuit as claimed in claim 1, wherein:
the delay control circuit receives, as an input, a detection result of an optical frequency component that is spaced apart from a center frequency of a carrier wave included in an optical spectrum of the output light of the optical modulator by the baud rate frequency component, and
the power monitor monitors a power of an electrical signal representing the detection result.

4. The delay control circuit as claimed in claim 1, further comprising:
a frequency generator configured to generate a clock frequency different from the baud rate frequency component; and
a multiplier configured to multiply the baud rate frequency component by the clock frequency,
wherein the power monitor monitors a power of the beat frequency component output from the multiplier.

5. An optical transmitter comprising:
a digital signal processor;
an optical modulator driven by signal bits output from the digital signal processor;
a delay control circuit configured to control a delay amount of the signal bits input to the optical modulator; and
a photodetector configured to detect a portion of output light of the optical modulator and output a detection result to the delay control circuit,
wherein the delay control circuit controls the delay amount of the signal bits so as to maximize a power of a baud rate frequency component including a frequency having a value equal to a baud rate or an integer multiple of the baud rate or a power of a beat frequency component of the baud rate frequency component, included in a detection result of the photodetector.

6. The optical transmitter as claimed in claim 5, wherein the delay control circuit includes:
a baud rate frequency filter configured to extract the baud rate frequency component from the detection result of the photodetector, and
a power monitor configured to monitor a power of the baud rate frequency component passed through the baud rate frequency filter.

7. The optical transmitter as claimed in claim 5, further comprising:
an optical filter configured to extract an optical frequency component spaced apart from a center frequency of a carrier wave by the baud rate frequency component from the output light of the optical modulator, wherein
the photodetector detects the optical frequency component transmitted through the optical filter, and
the delay control circuit controls the delay amount of the signal bits so as to maximize the power of the baud rate frequency component included in the detection result of the photodetector.

8. The optical transmitter as claimed in claim 5, wherein the delay control circuit includes:
a frequency generator configured to generate a clock frequency different from the baud rate frequency component, and
a multiplier configured to multiply the baud rate frequency component by the clock frequency, and
the delay control circuit controls the delay amount of the signal bits so as to maximize the power of the beat frequency component output from the multiplier.

9. The optical transmitter as claimed in claim 5, wherein:
the optical modulator includes a plurality of electrode segments provided in series along one or both of two waveguides forming a Mach-Zehnder interferometer, and
the delay control circuit controls the delay amount of each of the signal bits output from the digital signal processor.

10. A delay control method comprising:
changing a delay amount of signals input to a plurality of electrode segments provided in series along one or both of two waveguides of a Mach-Zehnder interferometer of an optical modulator;
monitoring, from output light of the optical modulator, a power of a baud rate frequency component including a frequency having a value equal to a baud rate or an integer multiple of the baud rate, or a power of a beat frequency component of the baud rate frequency component;
setting the delay amount to a value that maximizes the power of the monitored baud rate frequency component or the monitored beat frequency component.

11. The delay control method as claimed in claim 10, further comprising:
detecting a portion of the output light of the optical modulator by a photodetector; and
obtaining the baud rate frequency component from an electrical output of the photodetector.

12. The delay control method as claimed in claim 10, further comprising:
extracting, by an optical filter, an optical frequency component that is spaced apart from a center frequency of a carrier wave included in an optical spectrum of the output light of the optical modulator by the baud rate frequency component; and
detecting the optical frequency component transmitted through the optical filter by a photodetector; and
monitoring a power of an electrical signal representing the optical frequency component from a detection result of the photodetector.

13. The delay control method as claimed in claim 10, further comprising:
generating a clock frequency different from the baud rate frequency component;
multiplying the baud rate frequency component by the clock frequency to extract the beat frequency component; and
monitoring a power of the beat frequency component.
